(19) United States
(12) Patent Application Publication
(10) Pub. No.: US 2017/0053037 A1
(43) Pub. Date: Feb. 23, 2017

(54) VALIDATION OF INTERNET ADDRESS INPUT TO A DEVICE

(71) Applicant: Lenovo (Singapore) Pte. Ltd., New Tech Park (SG)

(72) Inventors: Joaquin F. Luna, Durham, NC (US); Russell Speight VanBlon, Raleigh, NC (US); Scott Wentao Li, Cary, NC (US); Robert James Kapinos, Durham, NC (US)

(21) Appl. No.: 14/828,735

(22) Filed: Aug. 18, 2015

(51) Int. Cl. G06F 17/30; H04L 29/08; H04L 29/12

(52) U.S. Cl. CPC G06F 17/30887; H04L 61/2546; H04L 67/02; G06F 17/30867

(57) ABSTRACT

In one aspect, a device includes a processor, a display accessible to the processor, and storage accessible to the processor that bears instructions executable by the processor to receive input comprising a uniform resource locator (URL), and in response to receipt of the input, at least attempt to validate the URL at least in part using a daemon. The instructions are also executable to, based at least in part on the attempt, provide an indication on a display of whether the URL is valid.

### FIELD

The present application relates generally to validation of an Internet address input to a device.

### BACKGROUND

Hyperlinks to web pages can be created based on user input of an Internet address. However, as recognized herein, if the Internet address is not input properly or contains a typo, and/or if a web page for the Internet address does not exist, a hyperlink created based on the Internet address will not, when selected, cause the intended web page to be presented. This defeats the purpose of creating a hyperlink and can lead to frustration.

### SUMMARY

Accordingly, in one aspect a device includes a processor, a display accessible to the processor, and storage accessible to the processor that bears instructions executable by the processor to identify input received at the device as pertaining to an Internet address and, in response to identification of the input as pertaining to an Internet address, perform a search based on the input to determine whether a web page associated with the Internet address is accessible. The instructions are also executable to present a notification on the display that the input does not pertain to a web page that is accessible in response to a determination that a web page associated with the Internet address is not accessible.

In another aspect, a method includes receiving input of a website address. The method also includes initiating a hypertext transfer protocol (HTTP) request based at least in part on the website address, receiving a response to the HTTP request, and determining, based at least in part on the response, whether the website address is associated with a page accessible over the Internet. The method further includes issuing a command to present a hyperlink on a display in response to a determination based at least in part on the response that the website address is associated with a page that is accessible over the Internet.

In still another aspect a computer readable storage medium that is not a transitory signal comprises instructions executable by a processor to receive input comprising a uniform resource locator (URL), where the input is directed to a window presented on a display accessible to the processor. The instructions are also executable to, in response to receipt of the input, at least attempt to validate the URL at least in part using a daemon, and to provide an indication on the display of whether the URL is valid based at least in part on the attempt.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 is a block diagram of a network of devices in accordance with present principles;

FIGS. 3 and 4 are flow charts showing example algorithms in accordance with present principles; and

FIGS. 5-10 are example user interfaces (UIs) in accordance with present principles.

### DETAILED DESCRIPTION

This disclosure relates generally to device-based information. With respect to any computer systems discussed herein, a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple, Google, or Microsoft. A Unix or similar such as Linux operating system may be used. These operating systems can execute one or more browsers such as a browser made by Microsoft or Google or Mozilla or other browser program that can access web applications hosted by the Internet servers over a network such as the Internet, a local intranet, or a virtual private network.

As used herein, instructions refer to computer-implemented steps for processing information in the system. Instructions can be implemented in software, firmware or hardware; hence, illustrative components, blocks, modules, circuits, and steps are set forth in terms of their functionality.

A processor may be any conventional general purpose single- or multi-chip processor that can execute logic by means of various lines such as address lines, data lines, and control lines and registers and shift registers. Moreover, any logical blocks, modules, and circuits described herein can be implemented or performed, in addition to a general purpose processor, in or by a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

Any software and/or applications described by way of flow charts and/or user interfaces herein can include various sub-routines, procedures, etc. It is to be understood that logic divulged as being executed by, e.g., a module can be redistributed to other software modules and/or combined together in a single module and/or made available in a shareable library.

Logic when implemented in software, can be written in an appropriate language such as but not limited to C# or C++, and can be stored on or transmitted through a computer-readable storage medium (e.g., that may not be a transitory signal) such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and twisted pair wires. Such connections may include wireless communication connections including infrared and radio.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

“A system having one or more of A, B, and C” (likewise “a system having one or more of A, B, or C” and “a system having one or more of A, B, C”) includes systems that have A alone, B alone, C alone, A and B together, A and C together, 8 and C together, and/or A, B, and C together, etc.

The term “circuit” or “circuitry” is used in the summary, description, and/or claims. As is well known in the art, the term “circuitry” includes all levels of available integration, e.g., from discrete logic circuits to the highest level, of circuit integration such as VLSI, and includes programmable logic components programmed to perform the functions of an embodiment as well as general-purpose or special-purpose processors programmed with instructions to perform those functions.

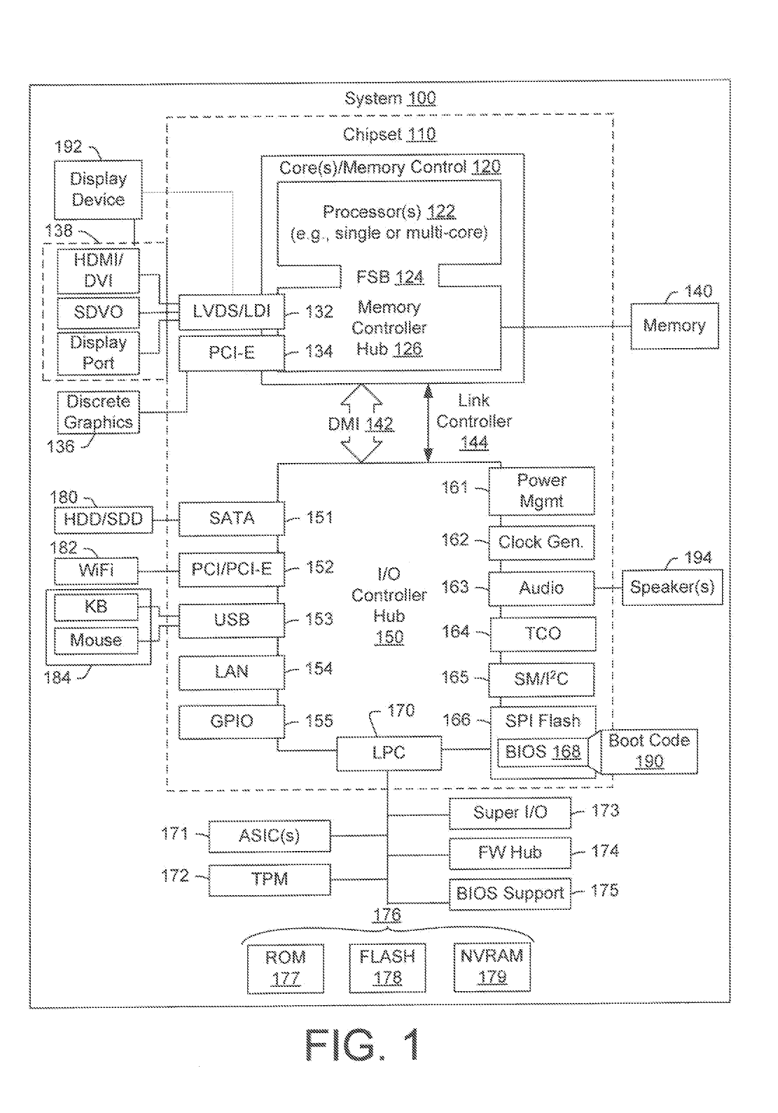

Now specifically in reference to FIG. 1, it shows an example block diagram of an information handling system and/or computer system 100. Note that in some embodiments the system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100. Also, the system 100 may be, e.g., a game console such as XBOX® or Playstation®.

As shown in FIG. 1, the system 100 includes a so-called, chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the conventional “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 further includes a low-voltage differential signaling interface (LVDS) 132. The LVDS 132 may be a so-called LVDS Display Interface (LDI) for support of a display device 192 (e.g., a CRT, a flat panel, a projector, a touch-enabled display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, tor support of discrete graphics 136. Discrete graphics using a PCI-E interface has become an alternative approach to an accelerated graphics port (AGP). For example, the memory controller hub 126 may include a 16-lane (x16) PCI-E port for an external PCI-E-based graphics card (including, e.g., one of more GPUs). An example system may include AGP or PCI-E for support of graphics.

The I/O hub controller 150 includes a variety of interfaces. The example of FIG. 1 includes a SATA interface 151, one or more PCI-E interfaces 152 (optionally one or more legacy PCI interfaces), one or more USB interfaces 153, a LAN interlace 154 (more generally a network interface tor communication over at least one network such as the Internet, a WAN, a LAN, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes BIOS 168 and boot code 190. With respect to network connections, the I/O hub controller 150 may include integrated gigabit Ethernet controller lines multiplexed with a PCI-E interface part. Other network features may operate independent of a PCI-E interface.

The interfaces of the I/O hub controller 150 provide for communication with various devices, networks, etc. For example, the SATA interface 151 provides for reading, writing or reading and writing information on one or more drives 180 such as HDDs, SDDs or a combination thereof, but in any case the drives 180 are understood to be, e.g., tangible computer readable storage mediums that may not be transitory signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

Additionally, though now shown for clarity, in some embodiments the system 100 may include a gyroscope tor sensing and/or measuring the orientation of the system 100 and providing input related thereto to the processor 122, an accelerometer for sensing acceleration and/or movement of the system 100 and providing input related thereto to the processor 122, an audio receiver/microphone providing input to the processor 122 based on, e.g., a user providing audible input to the microphone, and a camera for gathering one or more images and providing input related thereto to the processor 122. The camera may be a thermal imaging camera, a digital camera such as a webcam, a three-dimensional (3D) camera, and/or a camera otherwise integrated into the system 100 and controllable by the processor 122 to gather pictures/images and/or video. Still further, and also not shown for clarity, the system 100 may include a GPS transceiver that is configured to receive geographic position information from at least one satellite and provide the information to the processor 122. However, it is to be understood that another suitable position receiver other than a GPS receiver may be used in accordance with present principles to determine the location of the system 100.

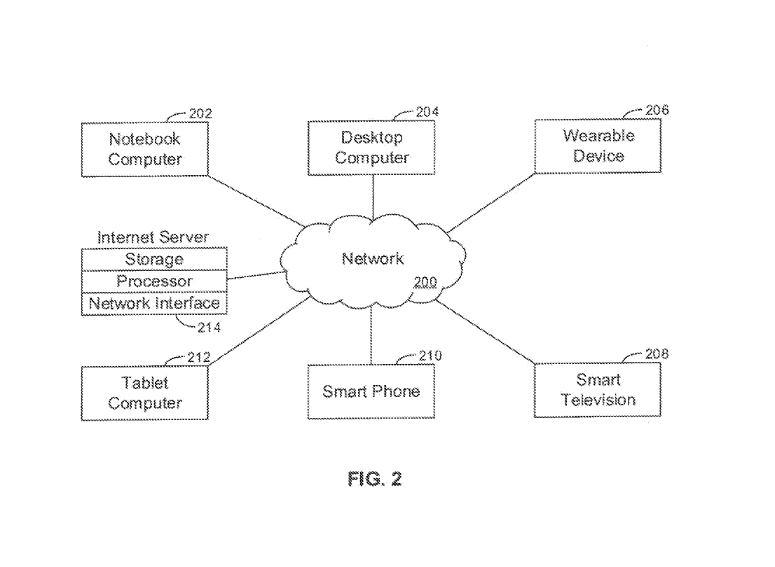

Before moving on to FIG. 2, it is to be understood that an example client device or other machine/computer may include fewer or more features than shown on the system 100 of FIG. 1. In any case, it is to be understood at least based on the foregoing that the system 100 is configured to undertake present principles.

Turning now to FIG. 2, it shows example devices communicating over a network 200 such as the Internet in accordance with present principles. It is to be understood that each of the devices described in reference to FIG. 2 may include at least some of the features, components, and/or elements of the system 100 described above. In any case, FIG. 2 shows a notebook computer 202, a desktop computer 204, a wearable device 206 such as a smart watch, a smart television (TV) 208, a smart phone 210, a tablet computer 212, and a server 214 such as an Internet server that may provide cloud storage accessible to the devices 202-212. It is to be understood that the devices 202-214 are configured to communicate with each other over the network 200 to undertake present principles.

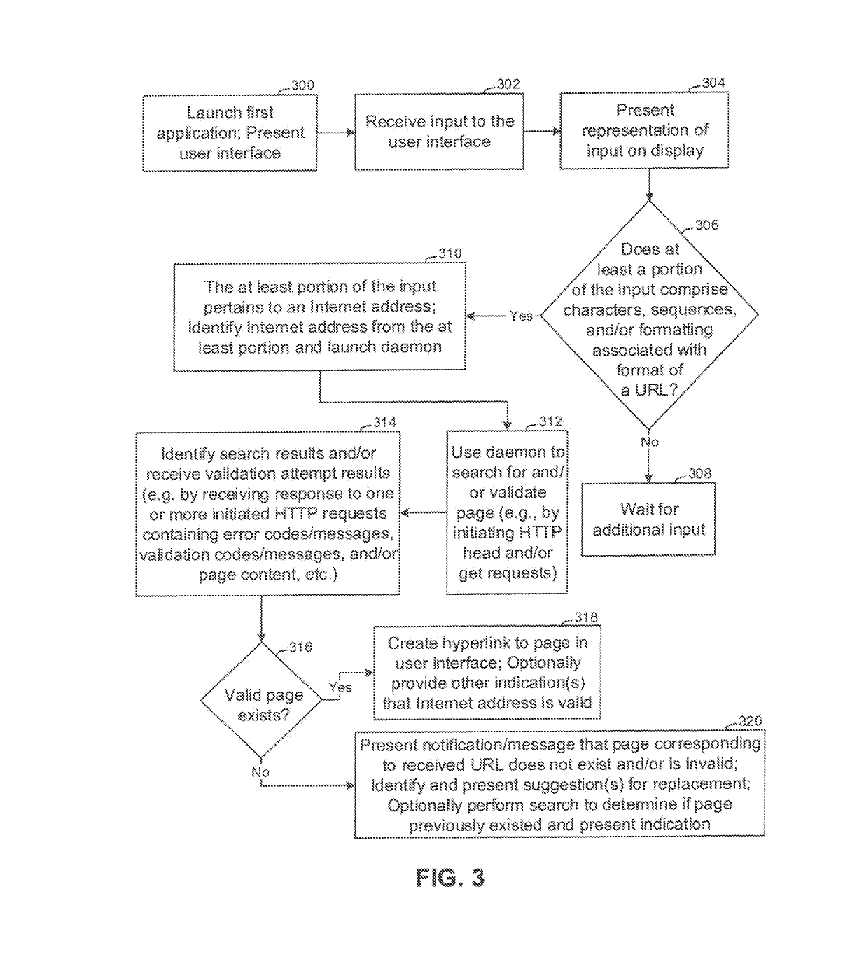

Referring to FIG. 3, it shows example logic that may be undertaken by a device such as the system 100 in accordance with present principles (referred to below as the “present device”). Beginning at block 300, the logic launches, initiates, and/or executes a first application for receipt of text input from a user, such as, e.g., a text messaging application, an email application, an instant message application, a word processing application, a web page content management application, etc. At block 300 the logic may also present, on a display accessible to the present device, a user interface (UI) associated with the first application at which the input may be directed by the user and received by the present device. Optionally, also at block 300 the logic may launch, initiate, and/or execute a second application different from the first application, such as a daemon or other background process, to monitor for input recognizable as an Internet address, such as a uniform resource locator (URL), as disclosed herein (though it is to be understood that in some embodiments the first application may do such monitoring as well or instead). Notwithstanding, it is to be understood that in some embodiments launch of the daemon may not occur until later, such as at block 310, which will be discussed below.

In any case, from block 300 the logic moves to block 302, where the logic receives input at the UI such as from a user. The logic then proceeds to block 304 where the logic presents on the UI a representation of the input, such as representations of alphabetical and numerical characters input by the user. The logic then proceeds to decision diamond 306 where the logic determines whether at least a portion of the input includes characters, sequences, and/or formatting associated with and/or indicative of the format of an Internet address.

As an example, the logic may parse the input and identify three characters in sequence each of the letter “w” (e.g., responsive to a pause in the input for a threshold time, responsive to selection of a space bar key, etc.), which may be recognized as being indicative of a world wide web address. As another example, if a portion of text separated on either end by spaces begins with the letters “http”, that is a format that may be identified by the logic as being indicative of an address as well. Still other characters by themselves may be indicative of an Internet address, albeit not a URL, such as the “@” of symbol used in email addresses.

Regardless, should a negative determination be made at diamond 306, the logic proceeds to block 308 where it may end, do nothing, or wait for additional input to the UI. However, should an affirmative determination be made at diamond 306, the logic instead moves to block 310. At block 310 the logic concludes that at least a portion of the input pertains to an Internet address, identifies the Internet address from the at least portion of the input, and if it has not already done so, launches a daemon or other background process (and/or even a foreground process and/or application visible to the user) for determining the existence and/or validity of a page associated with the identified address. Validity of a page, as used herein, may refer to the page being accessible over the open Internet without requirement of a specialized and/or unique access privilege(s) such as a pay subscription to access the page. Input of a user name and/or password to access the page, use of unique and/or specialized browser cookies to access the page, etc.

The logic then proceeds to block 312 where the logic uses the daemon or other process or application to search for and/or validate the Internet address (e.g., without the use of and/or access to cookies, login credentials, personalized data, etc. that may be required for accessing a given page etc.). The logic may do so, e.g., by entering the address into a search engine accessible to the present device, by entering it into an address field of a browser (e.g. stored at the present device and/or stored at another location (such as server) accessible to the present device) and initiating a HTTP get request by commanding the daemon to itself transmit a HTTP request such as a HTTP get request and/or a HTTP head request, etc.

From block 312 the logic proceeds to block 314 where the logic (e.g., via the daemon and/or using information therefrom) identifies and/or receives search results that are returned, and/or identifies validation attempt responses that are received. From block 314 the logic then moves to decision diamond 316 where the logic determines (e.g., via the daemon and/or information therefrom), based on the response(s) and/or results, whether a page exists and/or is valid that is associated with the Internet address.

For example, at block 314 the logic may receive a response from a server to one or more HTTP requests the logic initiated at block 312, where the response contained one or more error codes and/or messages. E.g., the response may contain a HTTP error code in the four hundred range or five hundred range, indicating among other things that a specific page for a given domain and/or parent website for the Internet address does not exist (such as where, e.g., www.espn.com is a domain/parent website but where the page www.espn.com/baseball does not exist) and/or is invalid owing to it being inaccessible without logging in to an account associated with the domain (which in some embodiments would be indicated by a four hundred one error code), as determined at diamond 316. As another example, the response received at block 314 may contain a HTTP validity code and/or message in the two hundred range, indicating that a page associated with the Internet address exists and/or is valid, as determined at diamond 316. As yet another example, the response received at block 314 may contain actual content and/or a HTML, (hypertext markup language) response for the page (such as if the request was a HTTP get request), which may be identified at diamond 316 by the logic as being indicative of a page for the Internet address existing and/or being valid.

Still in reference to FIG. 3, note that an affirmative determination at diamond 316 causes the logic to proceed to block 318. At block 318 the logic (e.g., using the first application) creates a hyperlink in the UI to the page, such as by replacing the representation of the text presented at block 304 that corresponds to the address with the hyperlink. Also at block 318, in some embodiments the logic may provide another indication(s) that the website address is valid besides presentation of the hyperlink itself. For example, other indications may include a green underlining of the hyperlink and a green “check mark” or other icon at least adjacent to if not overlaid on a portion of the hyperlink. Such indications will be discussed further below.

However, note that if instead at diamond 316 a negative determination is made, the logic instead moves from diamond 316 to block 320. At block 320 the logic (e.g., using the first application) presents at least one notification and/or message that a page corresponding to the Internet address does not exist and/or is invalid.

Also at block 320, the logic may identify and present on the display suggestions of addresses for valid and/or existing pages (or, e.g., email address suggestions for valid/existing email accounts if the Internet address that was received was an email address). The logic may do so at block 320, e.g., based on a particular HTTP error code that is received in response to a HTTP request. For instance, some of the error codes in the four hundreds (e.g. a four hundred four code or a four hundred ten code) that may be returned in response to a HTTP head request may be identified by the logic (e.g., based on accessing data in a data table that respectively associates error codes with statuses on page validity existence) as being error codes indicating that an associated domain and/or “parent” website exists but that a particular “child” page corresponding to the Internet address in the HTTP head request does not. In this example, the logic may identify the domain/parent website based on, e.g., the portion of the Internet address up to a portion ending in “.com” and suggest that address, and/or the logic may parse the Internet address received from the user and identify one or more key words therein to then execute a search (e.g., using an Internet-based search engine) using the key words for a relevant page (e.g., within the same domain/parent website) that matches the search and/or contains the key word(s).

As another example of how a suggestion may be provided, such a suggestion may be identified using an Internet-based search engine, where the Internet address received from the user is entered into the search engine and searched. Assuming a page for the particular address does not exist and/or is invalid, the search may return an indication that the page does not exist and/or is invalid (which may also be an additional way the logic may determine whether a page for the address exists and/or is valid) and may return search results of other pages for the same domain that exist and/or are valid. The logic may then identify and use as a suggestion at least the first search result for an existing and/or valid page that is returned based on the search (or, e.g., the first result through the Nth result).

As still another example of the types of suggestions that may be provided, syntax errors in the address as received from the user may be identified and replacements may be suggested. For example, certain characters are used for URLs, email addresses, or IP addresses (and even more specifically, merely a subset of those certain characters are acceptable for various specific portions of a URL such as a path portion or domain portion), so the logic, being able to identify those characters (e.g., based on data from a data table that is accessed and that contains only the acceptable characters), may also identify characters other than the acceptable ones that are included in the user input. The logic may then suggest one or more replacement characters for the unacceptable one (e.g. such as acceptable characters associated, with keys on a keyboard identified by the logic as being adjacent to a key associated with the unacceptable character), and/or may suggest entire addresses with the unacceptable character already replaced with an acceptable character with many if not all other characters remaining the same and/or in the same sequence (e.g., by inserting an acceptable character associated with an adjacent key for the unacceptable character, using an acceptable character which has at least a threshold number of times replaced the unacceptable one in past instances as may be identified based on past usage information stored at the device, based on search results that are returned based on a search of the address containing the unacceptable character, etc.).

Still describing suggestions, also note, for example, that should no response code be received in response to a HTML request, no suggestions may be provided based on the response code since a domain/parent website for the website may not exist in such a situation, though it is to also be understood that in such situations a suggestion may nonetheless be provided based on search engine results returned in response to a search using the address from the user as described herein.

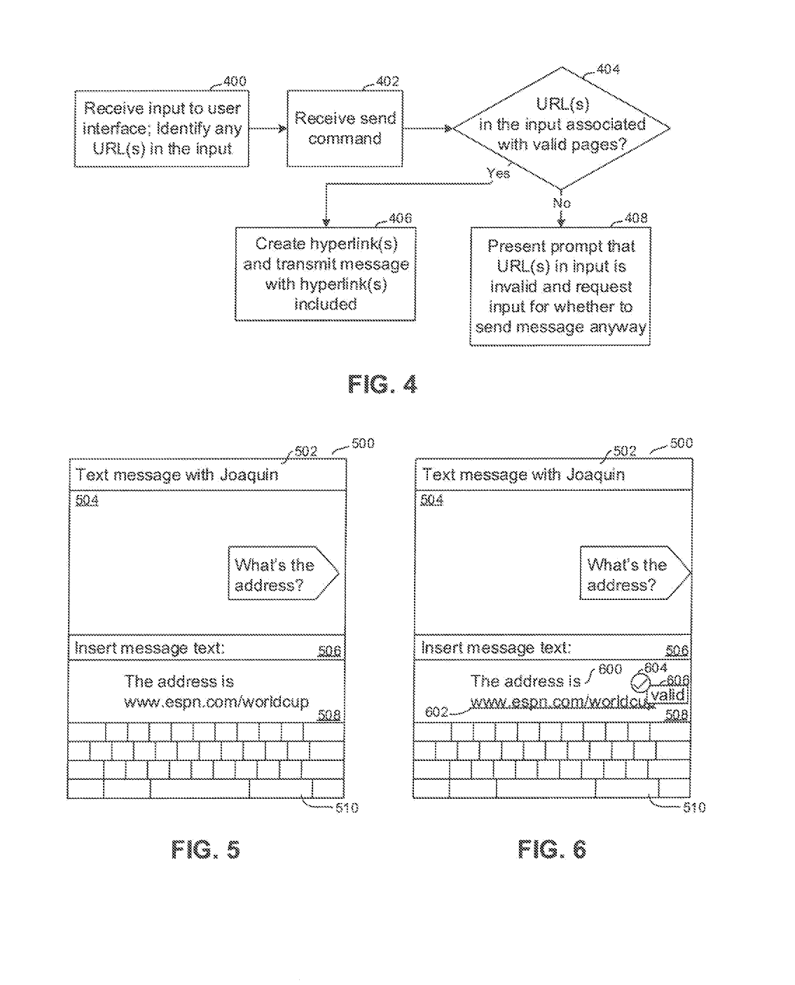

Before moving on to the description of FIG. 4, it is to be further understood in reference to block 320 of FIG. 3 that in addition to presenting a notification and/or message, and also in some embodiments in addition to presenting suggestions, the logic at block 320 may perform a search (e.g., using a search engine to search archived but no longer existing/valid pages) to determine if a page associated with the address input by the user had previously existed and/or was previously valid. If the search returns a result that the page did previously exist and/or was previously valid, an indication that such a page previously existed and/or was valid may be presented well.

Also before moving on to FIG. 4, it is to be understood that should a four hundred ten HTTP error code be received in response to a HTTP request, this error code may be recognized by the logic as indicating that a page associated with the address input by the user had previously existed but no longer does. Hence, receipt of a four hundred ten error code may be another parameter causing the logic to present an indication that a page associated with the address previously existed.

Now in reference to FIG. 4, it shows example logic that may be undertaken by a device such as the system 100 in accordance with present principles (referred to below as the “present device”). It is to be understood that the logic of FIG. 4 may in some embodiments be executed in conjunction with the logic of FIG. 3.

In any case, the logic of FIG. 4 begins at block 400 where the logic receives input to a user interface (UI) (such as an UI associated with a messaging application such as an email application or a text messaging application) and at least attempts to identify any Internet addresses from the input. The logic of FIG. 4 then moves to block 402 where the logic receives a command to transmit a message containing the characters of the input (including those that might pertain to an Internet address). Responsive to receipt of the send command, the logic then proceeds to decision diamond 404.

At diamond 404 the logic determines, as described herein, whether any Internet addresses identified from the input are associated with valid and/or existing pages (or, if the address was an email address, associated with valid and/or existing email accounts). An affirmative determination at diamond 404 causes the logic to move to block 406. At block 406 the logic inserts a hyperlink for the address into the message and without further user input transmits the message containing the hyperlink.

However, if a negative determination is made at diamond 404, the logic instead moves to block 408 where the logic presents a prompt that the address(es) that was input pertains to an invalid and/or nonexistent page and that requests user input for whether to transmit the message regardless of the address pointing to the invalid and/or nonexistent page.

Continuing the detailed description in reference to FIG. 5, it shows an example user interface (UI) 500 presentable on a display of a device such as the system 100 in accordance with present principles. The UI 500 is understood to be associated with a text messaging application and is manipulable to enter text for transmission as a text message. The UI 500 includes a recipient section 502 indicating a recipient of a text message to be composed using the UI 500, along with a past message section 504 showing one or more past text messages exchanged between the device and the recipient, which in this case includes a text message from the recipient asking “What's the address?” Instructions 506 indicate that text for a message may be entered at text entry field 508. As may be appreciated from FIG. 5, the text that has been entered to the device includes “The address is www.espn.com/worldcup”. The text may have been entered, e.g., based on manipulation of a virtual “soft” keyboard 510 presented on the display, which is understood to be touch-enabled to receive input selecting one or more of the virtual “soft” keys of the keyboard 510. However, note that input of the text may be received through other means as well, such as e.g. voice input being recognized and converted to text using a voice-to-text software application.

As may be appreciated from FIG. 6, the UI 500 is again shown. In this example, the address www.espn.com/worldcup has been determined to exist and/or has been validated as described herein (e.g., using a daemon), and accordingly it is to be understood that the text of the address www.espn.com/worldcup as entered has been replaced with a hyperlink 600 to the address www.espn.com/worldcup. This hyperlink may be selectable to automatically without further user input cause the device to present a page associated with the address www.espn.com/worldcup (e.g., by launching a browser and initiating a HTTP get request via the browser) and may be presented in the color green to indicate that a page for the hyperlink is valid and/or exists.

Furthermore, this hyperlink may be accompanied by one or more other indications (e.g., besides that the address has been made a hyperlink responsive to validation of the address) that a page for the address exists and/or is valid. As one example, the hyperlink includes underlining 602 that may be green, although this may not be appreciated from FIG. 6 owing to the restriction that drawings for U.S. patent applications generally be black and white. As another example, the hyperlink may include one or more icons at least adjacent if not overlaid on a portion of the hyperlink 600. One example icon is icon 604, which may appear next to the hyperlink 600 as a two-dimensional circle or three-dimensional sphere, have a check mark inside of the circle or sphere, and have at least a portion presented in the color green (e.g., the outline of the circle or sphere, the shading of the interior of the circle or sphere, and/or the check mark may be green). Another example icon is icon 606, which may appear next to the hyperlink 600 as a two-dimensional rectangle or three-dimensional box, have an indication/text of page existence and/or validity inside of the rectangle or box (e.g., in this case, the text “valid”, though other text may be used such as “exists”), and have at least a portion presented in the color green (e.g., the outline of the rectangle or box, the shading of the interior of the rectangle or box, and/or the indication/text may be green).

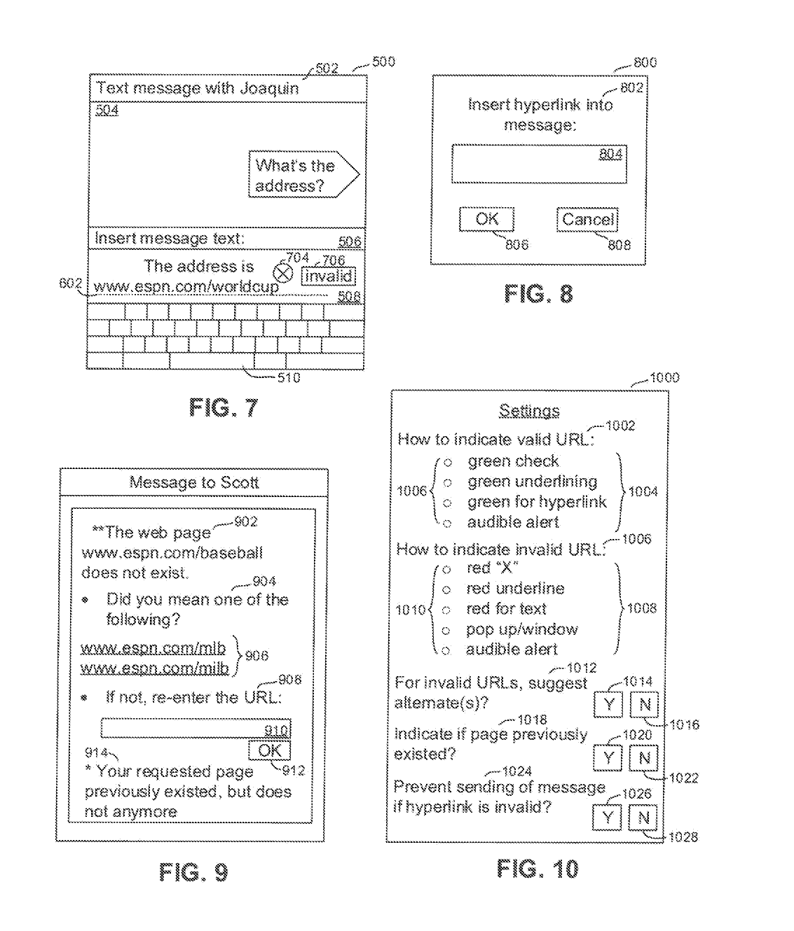

Now in reference to FIG. 7, the UI 500 is again shown. In this example, the address www.espn.com/worldcup has, once it has been input as text as shown in FIG. 5, been determined to not exist and/or be invalid as described herein (e.g., using a daemon), in contrast to the example described above in reference to FIG. 6, and accordingly it is to be understood that the text of the address www.espn.com/worldcup remains in FIG. 7 with no hyperlink to the address www.espn.com/worldcup being created.

However, distinguishing the text for the address as shown in FIG. 7 from how it is shown in FIG. 5, the text prior to the device's attempt to validate and/or determine the existence of a page for the address may be black as represented in FIG. 5, while the text after the device's attempt to validate and/or determine the existence of a page for the address may be red as represented in FIG. 7 owing to a determination by the device that a page for the address does not exist and/or is invalid.

Furthermore, the red text in FIG. 7 for presentation of the address www.espn.com/worldcup may be accompanied by one or more other indications that a page for the address does not exist and/or is invalid. As one example, the red text for the address presented in the field 508 may include underlining 702 different from the underlining 602 (e.g., dots for underlining 702 rather than strokes alternating in opposite directions for underlining 602), where the underlining 702 may also be presented in red coloring. As another example, the hyperlink may include one or more icons at least adjacent if not overlaid on a portion of the red text for the address. One example icon is icon 704, which may appear next to the red text for the address as a two-dimensional circle or three-dimensional sphere, have an “X” (and/or a circle-backslash symbol or a circle with a diagonal line through it) inside of the circle or sphere, and have at least a portion presented in the color red (e.g., the outline of the circle or sphere, the shading of the interior of the circle or sphere, and/or the “X” and/or circle-backslash symbol may be red). Another example icon is icon 706, which may appear next to the red text for the address as a two-dimensional rectangle or three-dimensional box, have an indication/text of page nonexistence or invalidity inside of the rectangle or box (e.g., in this case, the text “invalid”, though other text may be used such as “nonexistent”), and have at least a portion presented in the color red (e.g., the outline of the rectangle or box, the shading of the interior of the rectangle or box, and/or the indication/text may be red).

Reference is now made to FIG. 8, which shows an example UI 800 presentable on a display of a device undertaking present principles. The UI 800 is understood to be associated with an application for composing text, such as a word processing application, an email application, a text messaging application, etc. The UI 800 is also understood to be a dialog box for creating and editing hyperlinks that will subsequently be inserted into a different area at which text may be composed, such as the field 508. Thus, the UI 800 includes a prompt 802 for a user to enter at text entry field 804 an Internet address for the device to at least attempt to verify an associated page as being valid and/or existing, and for which a hyperlink will be created should such a page be valid and/or exist For example, after text has been entered into field 804, the user may selected the “ok” selector 806 which automatically without further user input may cause the device to at least attempt to verify the associated page as being valid and/or existing and, if valid/existing, automatically create a corresponding hyperlink. For completeness, note that a cancel selector 808 is also shown which is selectable to automatically without further user input cancel the request to create a hyperlink, close the UI 800, and return to a previously presented UI or screen.

In any case, should the device (responsive to selection the selector 806) determine that a page associated with an address input to the field 804 does exist and/or is valid, the device may automatically create a hyperlink and insert it in a location of another UI, such as a UI similar to the UI 500 described above, along with one or more indications that the address and/or hyperlink is valid. However, should the device determine that a page associated with an address input to the field 804 does not exist and/or is invalid, the UI 800 may be removed from the display and replaced with a UI 900 overlaid on at least a portion of the other UI previously presented.

The UI 900 of FIG. 9 includes an indication 902 that a page for the address input by the user (in this example, www.espn.com/baseball) does not exist and/or is invalid. The UI 900 also contains text 904 asking whether another address was intended to be provided. The text is accompanied by one or more suggestions 906 of addresses associated with pages that do exist and/or are valid (e.g., suggestions that may have been identified as set forth above), where each suggestion 906 is understood to be selectable to automatically without further user input create a hyperlink and insert it at a requested location.

Still further, the UI 900 may include additional text 908 requesting reentry to a text entry held 910 of the desired address (e.g., should there have been a typo in the previous entry) and/or requesting entry of another address for which to create a hyperlink to a page in accordance with present principles. After an address has been entered into box 910, ok selector 912 may be selected to automatically without further user input initiate the daemon to validate/verify existence of a page corresponding to the address.

Still in reference to FIG. 9, an indication 914 may also be presented in some embodiments. The indication 914 may indicate, if applicable and as determined as described herein, that a page associated with the address that was previously input did exist at one time but does not exist anymore.

Before moving on to the description of FIG. 10, it is to be understood that the UI 900 and/or any features thereof may be included in any of the other UIs described herein for indicating invalidity and/or nonexistence of a page in accordance with present principles, and thus need not be limited to an embodiment where a dialog box for creating and editing hyperlinks be presented that is separate from another UI at which the hyperlink and/or indications of validity/invalidity themselves are to be presented.

Now describing FIG. 10, it shows an example UI 1000 presentable on a display of a device in accordance with present principles. The UI 1000 is for configuring settings of an application and/or device to undertake present principles. The UI 1000 includes a first setting 1002 pertaining to methods of indicating that a particular Internet address pertains to a valid and/or existing page. Plural options 1004 are presented, with each one accompanied by a corresponding radio button 1006 selectable to automatically without further user input configure the application/device to take action in conformance with the respective option. As may be appreciated from FIG. 10, the options 1904 may include an option to indicate validity/existence using a green check as described herein, green underlining as described herein, green color for the hyperlink itself as described herein, and an audible alert (e.g., audio that “The address you provided pertains to a page that exists”, or “The address is valid”).

The UI 1000 also includes a second setting 1006 pertaining to methods of indicating that a particular Internet address pertains to an invalid and/or nonexistent page. Plural options 1008 are presented, with each one accompanied by a corresponding radio button 1010 selectable to automatically without further user input configure the application/device to take action in conformance with the respective option. As may be appreciated from FIG. 10, the options 1008 may include an option to indicate invalidity/nonexistence using a red “X” as described herein, red underlining as described herein, red color for text of the incorrect address as described herein, a pop up window (e.g., such as the UI 900 as described herein), and an audible alert (e.g., audio that “The address you provided does not pertain to a page that exists” or “The address is invalid”).

The UI 1000 may also include a third setting 1012 for selecting whether the device or application should present suggestions of alternate addresses for ones that are determined to be for pages that do not exist as described herein. Thus, a yes selector 1014 is presented that is selectable to enable the setting and hence present such suggestions, while a no selector 1016 is presented that is selectable to disable the setting and not present such suggestions.

Still further, the UI 1000 may include yet another setting 1018 for selecting whether the device or application should indicate, in appropriate circumstances as described herein, whether a notification/message should be provided that a page corresponding to an address provided by a user previously existed even if it does not exist anymore. A yes selector 1020 is presented that is selectable to enable the setting and hence present such notifications/messages, while a no selector 1022 is presented that is selectable to disable the setting and not present such notifications/messages.

What's more, the UI 1000 may include a setting 1024 for selecting whether to prevent transmission of a message that would otherwise be transmitted responsive to a user command to do so in instances where the message is determined to contain an address corresponding to an invalid and/or nonexistent page as disclosed herein. A yes selector 1026 is presented that is selectable to enable the setting and hence prevent transmission of such a message (e.g., at least without first presenting a UI similar to the UI 900 described above and/or that requests confirmation from a user to send the message anyway), while a no selector 1028 is presented that is selectable to disable the setting and thus transmit such a message responsive to a user command to do so regardless of whether an address in the message pertains to a page that exists and/or is valid, and/or regardless of whether one or more indications were presented that the address pertains to a page that does not exist and/or is invalid.

It may now be appreciated that present principles provide for, e.g., validating hyperlinks as they are added to a document, message, etc. When a hyperlink, is attempted to be added, a background task may be started to load a page specified in a URL. If the page, server, etc. returns an error code, then the hyperlink may be created but marked invalid and/or may not be created but corresponding text marked invalid. The user may then be given the chance to fix the URL.

In one example embodiment, once a URL is validated, a green check mark and/or a green icon may be presented while a URL that is determined to not be valid may be accompanied by a red “X” and/or a red icon.

Furthermore, in some example embodiments an application for receiving input of text (e.g. a word processor, an email application, a text messaging application, etc.) may present a separate dialog box for editing hyperlinks. An “ok” button and/or a send button may initiate URL validation and alert the user of any problems before closing the dialog box and/or warning the user that the message they are attempting to send contains an invalid URL. This alert and/or warning may itself include a button to, e.g., send a message anyway regardless or give the user a chance to fix the issue with a “let me fix it” button that automatically returns the user to the dialog box for editing hyperlinks.

Furthermore, it is to be understood that loading an entire page associated with a URL to determine validity may be used in some embodiments, while in other embodiments an HTTP HEAD command can be used to retrieve simply headers and a response code(s) from an associated server. E.g., a response code in the two hundreds may be received and be determined to be indicative of a valid page while an error code in the four hundreds or five hundreds may be received and be determined to be indicative of an invalid page (and in some instances for an invalid page, give the user feedback to help indicate what was wrong with the URL as input by him or her). Furthermore, in some instances where no connection can be made, the user may be informed that the page and/or associated server is unavailable (e.g. via a prompt, via red highlighting of just the domain portion of the address input by the user, etc.).

Also in some embodiments, syntax errors (e.g., spaces in the URL caused by selection of a space bar) may be identified by a device undertaking present principles and an error message can be provided alerting the user of the mistake. Corrections for the mistake may also be suggested, if desired.

Before concluding, it is to be understood that although “URL” or other terms may have been used herein in reference to addresses, other types of addresses are contemplated herein and may be used in some embodiments in conformance with present principles, such as email addresses and Internet protocol (IP) addresses.

Also before concluding, it is to be understood that although a software application for undertaking present principles may be vended with a device such as the system 100, present principles apply in instances where such an application is downloaded from a server to a device over a network such as the Internet. Furthermore, present principles apply in instances where such, an application is included on a computer readable storage medium that is being vended and/or provided, where the computer readable storage medium is not a transitory signal and/or a signal per se.

While the particular VALIDATION OF INTERNET ADDRESS INPUT TO A DEVICE is herein shown and described in detail, it is to be understood that the subject matter which is encompassed by the present application is limited only by the claims.

What is claimed is:

1. A device, comprising:
a processor;
a display accessible to the processor; and
storage accessible to the processor and bearing instructions executable by the processor to:
identify input received at the device as pertaining to an Internet address;
in response to identification of the input as pertaining to an Internet address, perform a search based on the input to determine whether a web page associated with the Internet address is accessible; and
in response to a determination that a web page associated with the Internet address is not accessible, present a notification on the display that the input does not pertain to a web page that is accessible.

2. The device of claim 1, wherein the instructions are executable to:
in response to a determination that a web page associated with the Internet address is accessible, create a hyperlink based at least in part on the input.

3. The device of claim 1, wherein the search is performed at least in part based on initiation of a hypertext transfer protocol (HTTP) head request, and wherein the determination that a web page associated with the Internet address is not accessible is based at least in part on receipt of an error message in response to the HTTP head request.

4. The device of claim 1, wherein the search is performed at least in part based on initiation of a hypertext transfer protocol (HTTP) get request and wherein the determination that a web page associated with the Internet address is not accessible is based at least in part on receipt of an error message in response to the HTTP get request.

5. The device of claim 1, wherein the search is performed at least in part using a first application different from a second application used to present a user interface (UI) at which the input is received.

6. The device of claim 5, wherein the first application is initiated in response to identification of the input as pertaining to an Internet address.

7. The device of claim 1, wherein the search is performed at least in part using a first application different from a second application used to present a user interface (UI) at which the notification is presented.

8. The device of claim 2, wherein the hyperlink is indicated at a user interface (UI) at which the input is received.

9. The device of claim 1, wherein the instructions are executable to:
in response to a determination that a web page associated with the Internet address is not accessible, present a notification on the display that the input does not pertain to a web page that is accessible and perform a search based on the input to determine if a web page associated with the Internet address was previously accessible.

10. The device of claim 9, wherein the instructions are executable to:
in response to a determination that a web page associated with the Internet address was previously accessible, present a notification on the display that a web page associated with the Internet address was previously accessible.

11. The device of claim 1, wherein the notification comprises one or more of:
an icon, a red marking at least adjacent to a location at which a representation of the input is presented, and a box indicating that the input does not pertain to a web page that is accessible.

12. The device of claim 1, wherein the instructions are executable to:
in response to a determination that a web page associated with the Internet address is not accessible, present at least one suggestion of an Internet address associated with a web page that is accessible, the at least one suggestion identified at least in part based on the input.

13. A method, comprising:
receiving input of a website address;
initiating a hypertext transfer protocol (HTTP) request based at least in part on the website address;
receiving a response to the HTTP request;
determining, based at least in part on the response, whether the website address is associated with a page accessible over the Internet; and
in response to a determination based at least in part on the response that the website address is associated with a page that is accessible over the Internet, issuing a command to present a hyperlink on a display.

14. The method of claim 13, comprising:
using a first application to initiate the HTTP request, the first application being different from a second application executed to present a user interface (UI) on the display at which the hyperlink is presented.

15. The method of claim 14, wherein the first application is a daemon.

16. The method of claim 13, wherein the HTTP request is a HTTP head request.

17. The method of claim 13, comprising:
in response to a determination based at least in part on the response that the website address is not associated with a page accessible over the Internet, issuing a command to present an indication on the display that the website address is not associated with a page accessible over the Internet.

18. The method of claim 13, comprising:
in response to the determination based at least in part on the response that the website address is associated with a page that is accessible over the Internet, issuing at least one command to present a hyperlink on the display and to present a green marking at least adjacent to the hyperlink on the display.

19. A computer readable storage medium that is not a transitory signal, the computer readable storage medium comprising instructions executable by a processor to:
receive input comprising a uniform resource locator (URL), the input directed to a window presented on a display accessible to the processor;
in response to receipt of the input, at least attempt to validate the URL at least in part using a daemon; and
based at least in part on the attempt, provide an indication on the display of whether the URL is valid.

20. The computer readable storage medium of claim 19, wherein the instructions are executable to:
determine at least in part using the daemon that the URL is invalid;
receive a request to transmit data comprising the URL; and
in response to receipt of the request, present a prompt on the display indicating that the URL is invalid.

21. The computer readable storage medium of claim 19, wherein the instructions are executable to:
determine at least in part using the daemon that the URL is valid; and
in response to the determination that the URL is valid, provide an indication on the display that the URL is valid, the indication comprising a hyperlink to a page associated with the URL.
